(19) United States
(12) Patent Application Publication
(10) Pub. No.: US 2026/0342629 A1
(43) Pub. Date: Oct. 29, 2026

(54) COMBINED WAVEFORMS FOR SIGNAL MODULATION

(71) Applicant: QUALCOMM Incorporated, San Diego, CA (US)

(72) Inventors: June NAMGOONG, San Diego, CA (US); Jing JIANG, San Diego, CA (US); Wei YANG, San Diego, CA (US); Akash Sandeep DOSHI, San Diego, CA (US)

(21) Appl. No.: 19/655,310

(22) Filed: Apr. 22, 2026

Related U.S. Application Data
(60) Provisional application No. 63/793,923, filed on Apr. 24, 2025.

(51) Int. Cl. H04L 27/233; H04L 25/03; H04L 27/26

(52) U.S. Cl. CPC H04L 27/2338; H04L 25/03834; H04L 27/2614; H04L 27/265

(57) ABSTRACT

Various aspects of the present disclosure generally relate to wireless communication. In some aspects, a wireless communication device may generate a first waveform according to a binary phase shift keying (BPSK) modulation scheme that includes a first sequence delay for a sequence of even numbered symbols that is up-sampled and rotated in phase, and a second sequence delay for a sequence of odd numbered symbols that is up-sampled. The wireless communication device may generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase. The wireless communication device may transmit a combined waveform. Numerous other aspects are described.

### CROSS-REFERENCE TO RELATED APPLICATION

This patent application claims priority to U.S. Provisional Patent Application No. 63/793,923, filed on Apr. 24, 2025, entitled “COMBINED WAVEFORMS FOR SIGNAL MODULATION,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with combined waveforms for signal modulation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, waveform construction may be used for data transmission. Waveform construction may include the transformation of coded bits into modulated symbols, followed by spectral shaping to adapt a signal to transmission guidelines or specifications. Techniques such as discrete Fourier transform (DFT) and circular convolution may be used to generate frequency domain samples for transmission via a communication channel. Advanced waveform construction incorporates methods like machine learning and gradient-based optimization to refine performance characteristics.

### SUMMARY

The systems, methods, and devices of this disclosure each have several innovative aspects, no single one of which is solely responsible for the desirable attributes disclosed herein.

Some aspects described herein relate to a wireless communication device. The wireless communication device may include a processing system. The processing system may include one or more processors and one or more code-storing memories coupled with the one or more processors. The processing system may be configured to cause the wireless communication device to generate a first waveform according to a binary phase shift keying (BPSK) modulation scheme that includes a first sequence delay for a sequence of even numbered symbols that is up-sampled and rotated in phase, and a second sequence delay for a sequence of odd numbered symbols that is up-sampled. The processing system may be configured to cause the wireless communication device to generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase. The processing system may be configured to cause the wireless communication device to transmit a combined waveform corresponding to the second waveform and the first waveform.

Some aspects described herein relate to a method of wireless communication performed by a wireless communication device. The method may include generating a first waveform according to a BPSK modulation scheme that includes a first sequence delay for a sequence of even numbered symbols that is up-sampled and rotated in phase, and a second sequence delay for a sequence of odd numbered symbols that is up-sampled. The method may include generating a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase. The method may include transmitting a combined waveform corresponding to the second waveform and the first waveform.

Some aspects described herein relate to a non-transitory computer-readable medium that stores a set of instructions for wireless communication by a wireless communication device. The set of instructions, when executed by one or more processors of the wireless communication device, may cause the wireless communication device to generate a first waveform according to a BPSK modulation scheme that includes a first sequence delay for a sequence of even numbered symbols that is up-sampled and rotated in phase, and a second sequence delay for a sequence of odd numbered symbols that is up-sampled. The set of instructions, when executed by one or more processors of the wireless communication device, may cause the wireless communication device to generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase. The set of instructions, when executed by one or more processors of the wireless communication device, may cause the wireless communication device to transmit a combined waveform corresponding to the second waveform and the first waveform.

Some aspects described herein relate to an apparatus for wireless communication. The apparatus may include means for generating a first waveform according to a BPSK modulation scheme that includes a first sequence delay for a sequence of even numbered symbols that is up-sampled and rotated in phase, and a second sequence delay for a sequence of odd numbered symbols that is up-sampled. The apparatus may include means for generating a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase. The apparatus may include means for transmitting a combined waveform corresponding to the second waveform and the first waveform.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a transmit chain and a receive chain of a wireless communication device.

FIGS. 3A-3C are diagrams illustrating an example associated with combined waveforms for signal modulation

FIG. 4 is a diagram illustrating an example process performed, for example, at a wireless communication device or an apparatus of a wireless communication device.

FIG. 5 is a diagram of an example apparatus for wireless communication.

### DETAILED DESCRIPTION

In wireless communication systems, modulation schemes, such as binary phase shift keying (BPSK), are commonly used to encode data for transmission. Modulation varies a carrier signal to transmit data. In BPSK, each bit of data is represented by one of two phases of the carrier signal, typically 0 and 180 degrees. One specific variant, π/2-BPSK, has gained attention for its ability to achieve a low peak-to-average power ratio (PAPR). In π/2-BPSK, the phase of the carrier signal shifts by 90 degrees (π/2 radians) between consecutive symbols.

Lowering PAPR may enhance power efficiency and reduce the likelihood of signal distortion during transmission. PAPR is the ratio of the peak power of the signal to its average power. High PAPR signals can cause power amplifiers to operate inefficiently, leading to non-linear distortion and spectral regrowth, which can interfere with adjacent channels and degrade overall system performance. However, even with n/2-BPSK, challenges remain in achieving a low PAPR.

Traditional waveform construction methods for π/2-BPSK involve encoding N coded bits to be transmitted over N resource elements (REs). These bits are converted into BPSK symbols, which are then modulated and transformed into the frequency domain using techniques such as the discrete Fourier transform (DFT). To further shape the spectrum and reduce PAPR, a spectral shaping window is applied either in the frequency domain or equivalently in the time domain through circular convolution with an impulse response derived from the inverse DFT (IDFT) of the shaping window.

In practical implementations, the spectral shaping alone may not adequately reduce the PAPR to the levels required for optimal performance. Consequently, systems that rely solely on these traditional techniques may experience suboptimal power efficiency and increased signal distortion. This is particularly pertinent in scenarios where efficient power usage and high signal integrity are paramount, such as in low signal-to-noise ratio (SNR) environments or when dealing with limited power budgets.

Moreover, the design and optimization of pulse shaping filters are complex tasks that require careful consideration of various parameters to ensure that the desired performance metrics are met. Traditional approaches may not fully exploit the potential of advanced optimization techniques, leading to less than optimal filter designs that fail to minimize PAPR. Additionally, some traditional designs may not sufficiently address the trade-offs between PAPR reduction and other performance metrics, such as spectral efficiency and mutual information.

Various aspects relate generally to waveform design for wireless communication to reduce PAPR. Some aspects more specifically relate to constructing a combined waveform based on a π/2-BPSK modulation scheme by combining two waveforms to achieve lower PAPR. The first waveform is generated according to a π/2-BPSK modulation scheme, which includes a first sequence delay for a sequence of even-numbered symbols that is up-sampled and rotated in phase by π/2, and a second sequence delay for a sequence of odd-numbered symbols that is up-sampled. The second waveform is generated by applying the first sequence delay to a sequence of products of even-numbered sets of adjacent symbols that is up-sampled, and applying the second sequence delay to a sequence of products of odd-numbered sets of adjacent symbols that is up-sampled and rotated in phase by π/2. This second waveform is specifically designed to reduce the PAPR of the first waveform. The combined waveform is obtained by summing the second waveform with the first waveform and is transmitted over a plurality of resource elements.

In some aspects, the first and second waveforms are combined by performing a DFT on the summed waveform according to the quantity of resource elements needed for transmission. Additionally, pulse shaping filters may be applied to both the first and second waveforms, where these filters can be calculated using machine learning algorithms or gradient-based refinement procedures to optimize performance.

By generating and combining the first and second waveforms as described, the techniques can effectively reduce the PAPR of the transmitted signal. This reduction in PAPR enhances power efficiency and reduces the likelihood of signal distortion during transmission, which is crucial for maintaining high signal integrity, especially in low SNR environments or when operating with limited power budgets. In this way, communicating using the combined waveform may conserve power resources and improve signal integrity in wireless communication systems.

Using advanced optimization techniques to calculate the pulse shaping filters helps achieve a lower PAPR, further enhancing the performance of the wireless communication system. Additionally, communicating using the combined waveform allows for the efficient use of existing modulation schemes while addressing the inherent limitations of traditional spectral shaping techniques, providing a robust solution for modern communication systems. In this way, a wireless communication device may conserve processing resources and optimize spectral efficiency, enabling more efficient transmission and better utilization of available spectrum resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

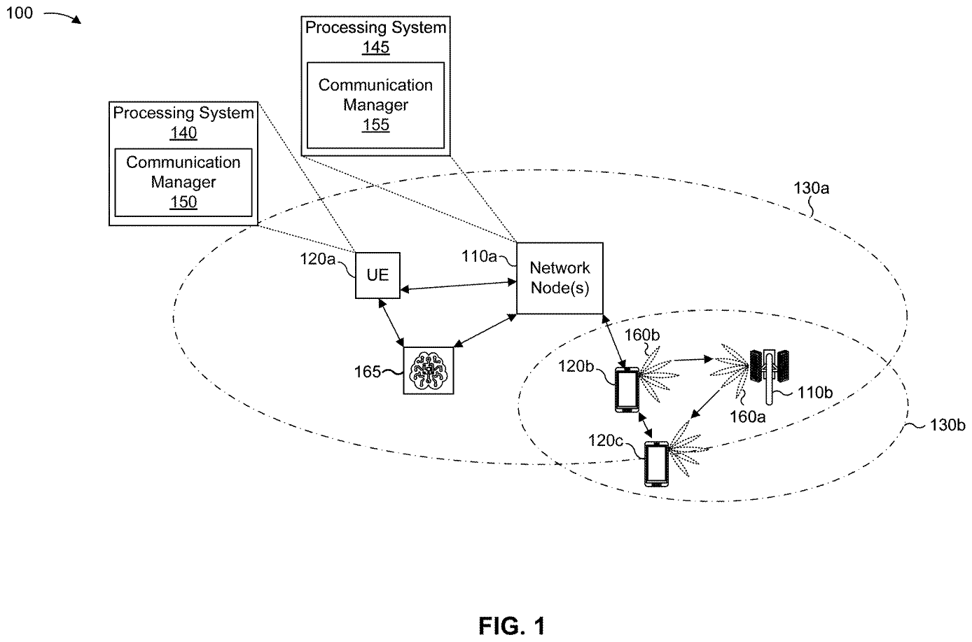

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple user equipments (UEs) 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the wireless communication device may include a communication manager 150 or a communication manager 155. As described in more detail elsewhere herein, the communication manager 150 or the communication manager 155 may generate a first waveform according to a BPSK modulation scheme that includes a first sequence delay for a sequence of even numbered symbols that is up-sampled and rotated in phase, and a second sequence delay for a sequence of odd numbered symbols that is up-sampled; generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase; and transmit a combined waveform corresponding to the second waveform and the first waveform. Additionally, or alternatively, the communication manager 150 or the communication manager 155 may perform one or more other operations described herein.

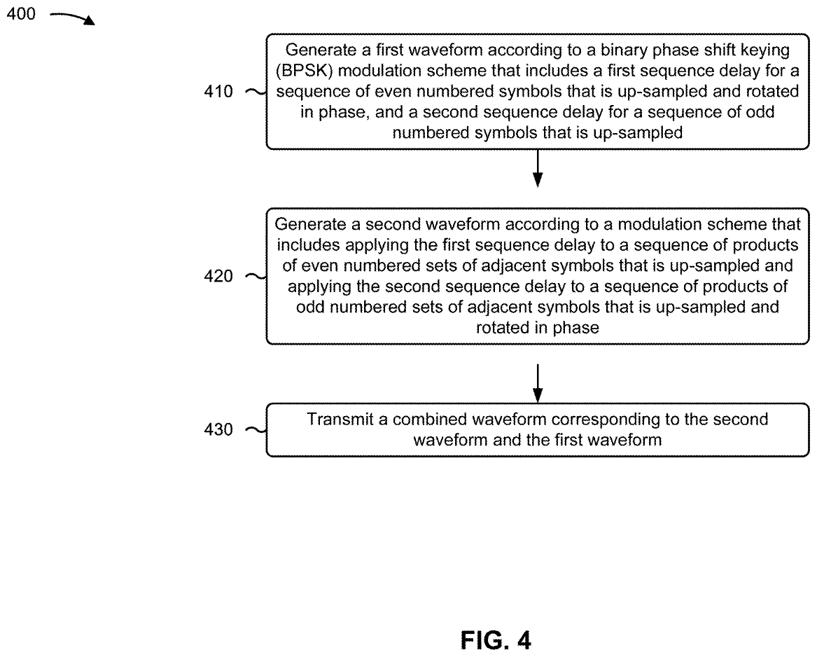

The network node 110, the processing system 145 of the network node 110, the UE 120, the processing system 140 of the UE 120, or any other component(s) of FIG. 1 may implement one or more techniques or perform one or more operations associated with combined waveforms for signal modulation, as described in more detail elsewhere herein. For example, the processing system 145 of the network node 110, or the processing system 140 of the UE 120 may perform or direct operations of, for example, process 400 of FIG. 4, or other processes as described herein (alone or in conjunction with one or more other processors). In some aspects, the wireless communication device described herein is the network node 110, is included in the network node 110, or includes one or more components of the network node 110 shown in FIG. 1. In some aspects, the wireless communication device described herein is the UE 120, is included in the UE 120, or includes one or more components of the UE 120 shown in FIG. 1. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, or other processes as described herein. In some examples, executing instructions may include running the instructions, converting the instructions, compiling the instructions, or interpreting the instructions, among other examples.

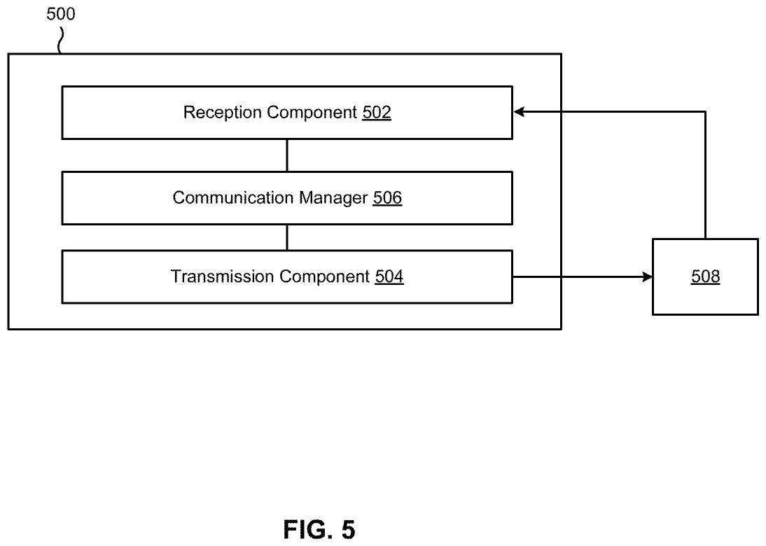

In some aspects, the wireless communication device includes means for generating a first waveform according to a BPSK modulation scheme that includes a first sequence delay for a sequence of even numbered symbols that is up-sampled and rotated in phase, and a second sequence delay for a sequence of odd numbered symbols that is up-sampled; means for generating a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase; or means for transmitting a combined waveform corresponding to the second waveform and the first waveform. In some aspects, the means for the wireless communication device to perform operations described herein may include, for example, one or more of communication manager 155, processing system 145, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples. In some aspects, the means for the wireless communication device to perform operations described herein may include, for example, one or more of communication manager 150, processing system 140, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples.

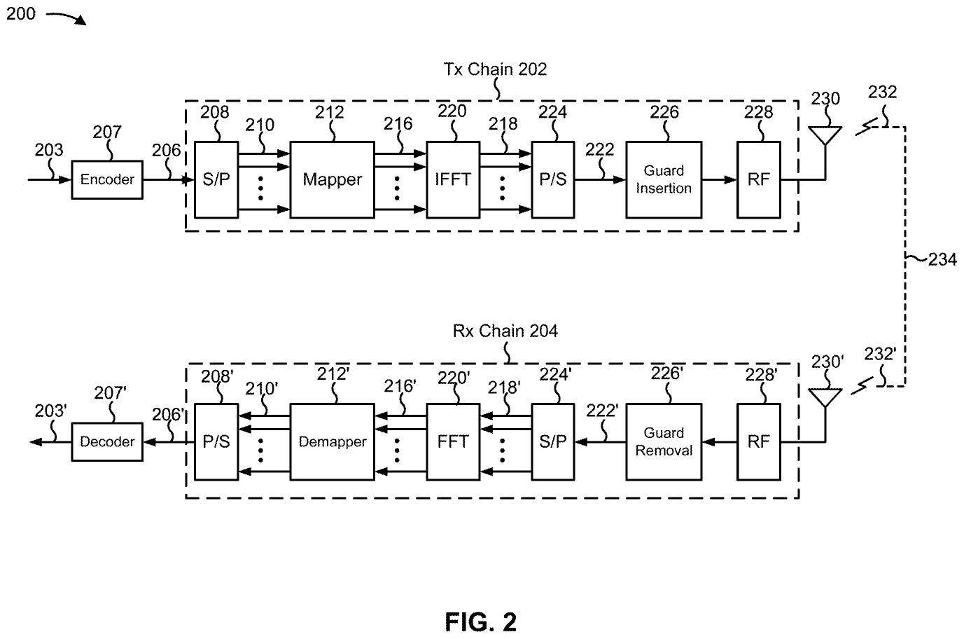

FIG. 2 is a diagram illustrating an example 200 of a transmit (Tx) chain 202 and a receive (Rx) chain 204 of a wireless communication device (E.g., UE 120, network node 110). In some aspects, one or more components of Tx chain 202 may be implemented in one or more components of a processing system, such as the processing system 140 described in connection with FIG. 1. In some aspects, Tx chain 202 may be implemented in wireless communication device for transmitting data 206 (e.g., uplink data, an uplink reference signal, uplink control information or downlink data, a downlink reference signal, or downlink control information) to an another wireless communication device via an uplink or a downlink channel.

An encoder 207 may alter a signal (e.g., a bitstream) 203 into data 206. Data 206 to be transmitted is provided from encoder 207 as input to a serial-to-parallel (S/P) converter 208. In some aspects, S/P converter 208 may split the transmission data into N parallel data streams 210.

The N parallel data streams 210 may then be provided as input to a mapper 212. Mapper 212 may map the N parallel data streams 210 onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper 212 may output N parallel symbol streams 216, each symbol stream 216 corresponding to one of N orthogonal subcarriers of an IFFT component 220. These N parallel symbol streams 216 are represented in the frequency domain and may be converted into N parallel time domain sample streams 218 by IFFT component 220.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to N_{cp} (the number of guard samples per OFDM symbol)+N (the number of useful samples per OFDM symbol).

The N parallel time domain sample streams 218 may be converted into an OFDM/OFDMA symbol stream 222 by a parallel-to-serial (P/S) converter 224. A guard insertion component 226 may insert a guard interval between successive OFDM/OFDMA symbols in the OFDM/OFDMA symbol stream 222. The output of guard insertion component 226 may then be upconverted to a desired transmit frequency band by a radio frequency (RF) front end 228. An antenna 230 may then transmit the resulting signal 232.

In some aspects, Rx chain 204 may utilize OFDM/OFDMA. In some aspects, one or more components of Rx chain 204 may be implemented in one or more components of a processing system, such as the processing system 140 described in connection with FIG. 1. In some aspects, Rx chain 204 may be implemented in the wireless communication device for receiving data 206 (e.g., uplink data, an uplink reference signal, uplink control information or downlink data, a downlink reference signal, or downlink control information) from another wireless communication device via a downlink or an uplink channel.

A transmitted signal 232 is shown traveling over a wireless channel 234 from Tx chain 202 to Rx chain 204. When a signal 232′ is received by an antenna 230′, the received signal 232′ may be downconverted to a baseband signal by an RF front end 228′. A guard removal component 226′ may then remove the guard interval that was inserted between OFDM/OFDMA symbols by guard insertion component 226.

The output of guard removal component 226′ may be provided to an S/P converter 224′. The output may include an OFDM/OFDMA symbol stream 222′, and S/P converter 224′ may divide the OFDM/OFDMA symbol stream 222′ into N parallel time-domain symbol streams 218′, each of which corresponds to one of the N orthogonal subcarriers. An FFT component 220′ may convert the N parallel time-domain symbol streams 218′ into the frequency domain and output N parallel frequency-domain symbol streams 216′.

A demapper 212′ may perform the inverse of the symbol mapping operation that was performed by mapper 212, thereby outputting N parallel data streams 210′. A P/S converter 208′ may combine the N parallel data streams 210′ into a single data stream 206′. Ideally, data stream 206′ corresponds to data 206 that was provided as input to Tx chain 202. Data stream 206′ may be decoded into a decoded data stream 203′ by decoder 207′.

A wireless communication device, such as a UE or a network node, may transmit a modulated signal to another wireless communication device, such as a UE or a network node. For example, the wireless communication device may modulate a data stream using phase shift keying (PSK) modulation, such as BPSK or QPSK, among other examples. Additionally, or alternatively, the wireless communication device may apply a multiplexing modulation technique to combine a set of data streams into a single signal across a set of orthogonal subcarriers. For example, the wireless communication device may apply OFDM modulation waveforms, such as DFT-s-OFDM or CP-OFDM, among other examples.

A peak-to-average power ratio (PAPR) is a ratio of peak power of a signal to average power of the signal. The PAPR value may be measured for a transmitted signal in an OFDM system. Lower PAPR values may be desirable for achieving efficient performance of a system. For example, lower PAPR values may enable greater power amplifier efficiency, reduced signal distortion, improved battery life, improved spectral efficiency, and higher link reliability and quality of service (QoS), relative to higher PAPR values. Accordingly, some wireless communication devices may select DFT-s-OFDM modulation waveforms, which may achieve lower PAPR values than CP-OFDM modulation achieves under similar conditions. Selecting DFT-s-OFDM may enable a wireless communication device to apply smaller (or no) power backoff relative to selecting CP-OFDM, which may provide for improved coverage. Similarly, some wireless communication devices may select π/2 BPSK (which rotates alternating BPSK symbols by a rotation of π/2), which may achieve lower PAPR values than regular (non-π/2 rotated) BPSK, by reducing an adverse effect of a main sidelobe from adjacent symbols. When using π/2 BPSK, a wireless communication device may apply a frequency domain spectral shaping (FDSS) filter to reduce PAPR and allow the wireless communication device to drive a power amplifier to a saturation level and achieve an output of a maximum possible power to achieve coverage enhancement.

When generating a waveform for transmission using rank-2 π/2 BPSK with an FDSS filter, a wireless communication device may map demodulation reference signal (DMRS) resource elements (REs) for each layer in an orthogonal manner. In other words, a wireless communication device may map even-indexed REs to a first layer and odd-indexed REs to a second layer in a frequency domain to enable channel estimation to be performed on a per-layer basis. To generate a waveform, the wireless communication device may perform a set of operations, such as the layer mapping, DFT precoding and FDSS filtering, precoding, subcarrier mapping, and IFFT processing. The wireless communication device may map modulated data symbols to antenna ports based on generating the waveform and may transmit the waveform from the antenna. At a receive side, the other wireless communication device may reverse the set of operations to recover a data stream.

PAPR is a key metric in wireless communications, especially in systems using multi-carrier modulation techniques like orthogonal frequency division multiplexing. PAPR is the ratio between the maximum instantaneous power of a signal and its average power. In wireless systems, especially ones using OFDM, a signal can exhibit large peaks due to the constructive interference of multiple subcarriers which may lead to a high PAPR.

High PAPR can cause reduced efficiency for power amplifiers, and increased signal distortion. Further, high PAPR may cause a higher dynamic range during signal conversion which may in turn increase cost, complexity, and power consumption of UE operations. By the wireless communication device using a combined waveform that includes a π/2 BPSK and an additional waveform, the wireless communication device may decrease PAPR thereby decreasing distortion and increasing energy efficiency.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more functions described as being performed by another set of components shown in FIG. 2.

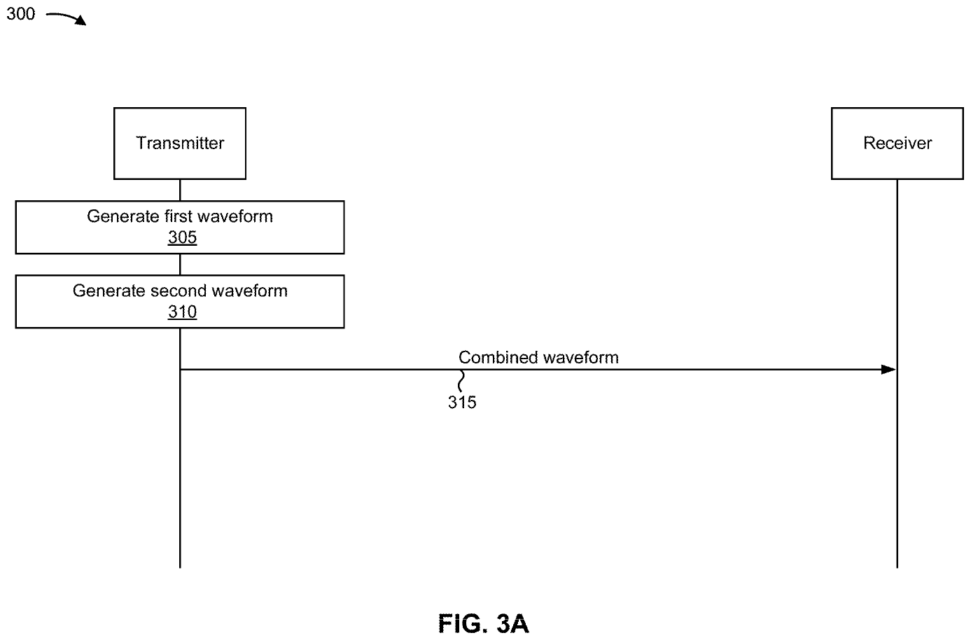

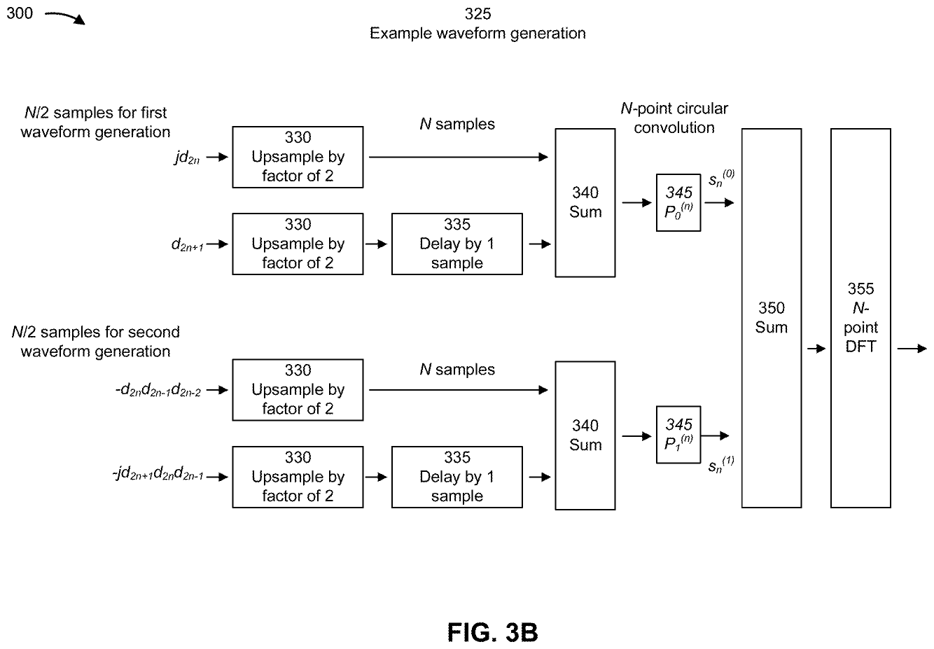

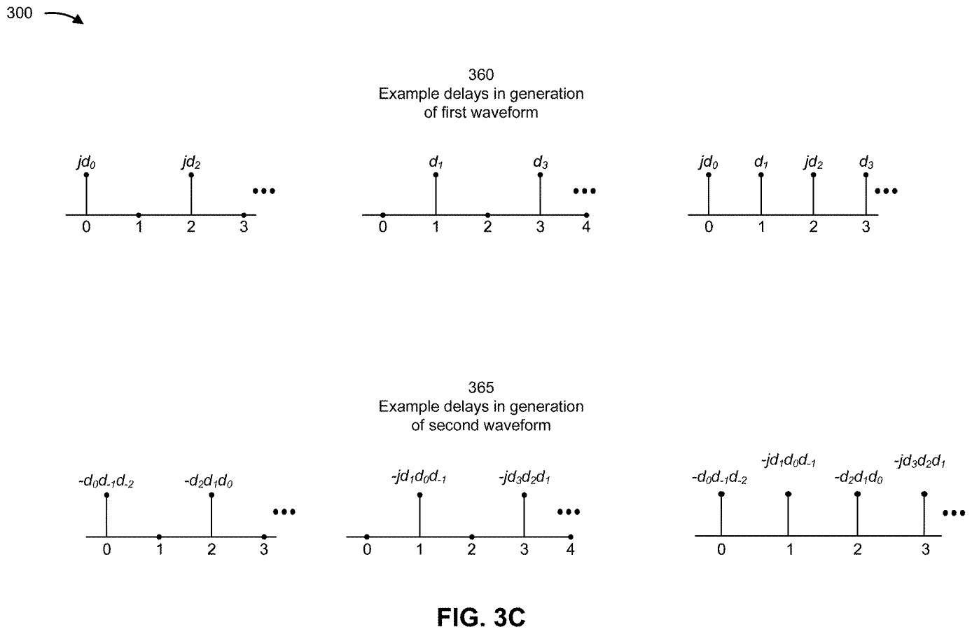

FIGS. 3A-3C are diagrams illustrating an example 300 associated with combined waveforms for signal modulation. As shown in FIG. 3A, example 300 includes communication between a transmitter (for example, a wireless communication device, including a network node 110 or a UE 120) and a receiver (for example, another wireless communication device, including a network node 110 or a UE 120). In some aspects, the transmitter and the receiver may be included in a wireless network, such as wireless communication network 100. The transmitter and the receiver may communicate via a wireless access link, which may include an uplink and a downlink.

In some aspects, as shown by reference number 305, the transmitter may generate a first waveform according to a π/2-BPSK modulation scheme that includes a first sequence delay for a sequence of even-numbered symbols that is up-sampled and rotated in phase by π/2, and a second sequence delay for a sequence of odd-numbered symbols that is up-sampled. In some aspects, generating the first waveform may include applying a first pulse shaping filter to the sequence of the even-numbered symbols and to the sequence of the odd-numbered symbols. For example, the transmitter may use a digital filter as a pulse shaping filter to shape the spectrum of each symbol prior to transmission. In this way, the π/2-BPSK modulation scheme may allow for efficient symbol transmission while maintaining the waveform's peak-to-average power ratio and its bandwidth.

In some aspects, the transmitter may calculate the first pulse shaping filter using a machine learning algorithm. In some other aspects, the transmitter may calculate the first pulse shaping filter using a gradient-based refinement procedure. Additionally or alternatively, in some aspects, the first sequence delay may be less than the second sequence delay. For example, the transmitter may adjust timing configurations to prioritize certain sequences for transmission.

In some aspects, the first waveform may be calculated using an equation of a form:

$${s}_{n}^{( 0 )} = \{ {\sum }_{l = 0}^{\frac{N}{2} - 1} ( {jd}_{2 l} δ ( n - 2 l ) + {d}_{2 l + 1} δ ( n - 2 l - 1 ) ) \} * {p}_{0} ( n ) ,$$

$$where {s}_{n}^{( 0 )}$$

is the first waveform, N is a quantity of coded bits to be transmitted, l is an integer, j is a unit imaginary number, a first symbol delay is 2l, a second symbol delay is 2l+1, d₂ₗ is a 2l^{th} BPSK symbol transmitted at the first symbol delay, d₂ₗ₊₁ is a (2l+1)^{th} BPSK symbol transmitted at the second symbol delay, n is an integer time index ranging from 0 to N−1, * is an N-point circular convolution operator, δ(n) is a discrete time impulse function, and p₀(n) is a pulse shaping filter and is a function of n. Additionally or alternatively, the sequence of even-numbered symbols may include {do, d₂, d₄, . . . , d₂ₗ, . . . , d_{N-2}} and the sequence of odd-numbered symbols may include {d₁, d₃, d₅, . . . , d₂ₗ₊₁, . . . , d_{N-1}}. For example, the transmitter may organize symbols into distinct sequences for strategic waveform construction.

In some aspects, as shown by reference number 310, the transmitter may generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase by π/2. In such aspects, the first waveform and the second waveform may be generated to reduce a peak-to-average power ratio of the first waveform. In this way, the modulation scheme may enable the reduction of the waveform's PAPR.

In some aspects, a zeroth even numbered set of adjacent symbols includes a zeroth symbol, a negative first symbol, and a negative second symbol (e.g., {d₀, d₋₁, d₋₂}), a zeroth odd numbered set of adjacent symbols includes a first symbol, the zeroth symbol, and the negative first symbol (e.g., {d₁, d₀, d₋₁}), a first even numbered set of adjacent symbols includes a second symbol, the first symbol, and the zeroth symbol (e.g., {d₂, d₁, d₀}), a first odd numbered set of adjacent symbols includes a third symbol, the second symbol, and the first symbol (e.g., {d₃, d₂, d₁}), a second even numbered set of adjacent symbols includes a fourth symbol, the third symbol, and the second symbol (e.g., {d₄, d₃, d₂}), and a second odd numbered set of adjacent symbols includes a fifth symbol, the fourth symbol, and the third symbol (e.g., {d₅, d₄, d₃}). For example, the even numbered sets of adjacent symbols may include {{d₀, d₋₁, d₋₂}, {d₂, d₁, d₀}, {d₄, d₃, d₂}, . . . , {d₂ₗ, d₂ₗ₋₁, d₂ₗ₋₂}, . . . , {d_{N-2}, d_{N-3}, d_{N-4}}}, and the sequence of products of the even numbered sets of adjacent symbols may include {d₀d₋₁d₋₂, d₂d₁d₀, d₄d₃d₂, . . . , d₂ₗd₂ₗ₋₁d₂ₗ₋₂, . . . , d_{N-2}d_{N-3}d_{N-4}}, and the odd numbered sets of adjacent symbols may include {{d₁, d₀, d₋₁}, {d₃, d₂, d₁}, {d₅, d₄, d₃}, . . . , {d₂ₗ₊₁, d₂ₗ, d₂ₗ₋₁}, . . . , {d_{N-1}, d_{N-2}, d_{N-3}}}, and the sequence of products of the odd numbered sets of adjacent symbols may include {d₁d₀d₋₁, d₃d₂d₁, d₅d₄d₃, . . . , d₂ₗ₊₁d₂ₗd₂ₗ₋₁, . . . , d_{N-1}d_{N-2}d_{N-3}}.

The sequence of BPSK symbols dₙ is constructed from the coded bit sequence bn according to dₙ=1−2bₙ for n=0, 1, . . . , N−1, where N is the total quantity of coded bits to be transmitted. The sequence dₙ is assumed to be periodic with period N, such that d_{n+kN}=d for any integer k. When calculating sets of adjacent symbols (e.g., d₂ₗd₂ₗ₋₁d₂ₗ₋₂; d₂ₗ₊₁d₂ₗd₂ₗ₋₁), indices outside the range 0≤n<N are interpreted via this periodic extension. Thus, for any negative index or index greater than or equal to N, the value is obtained by wrapping the index modulo N. For example, d₋₁ refers to d_{N-1}, and d_{N} refers to d₀.

The even numbered sets of adjacent symbols refer to sets starting with 2l for l=0, 1, . . . , N/2−1, and the odd numbered sets of adjacent symbols refer to sets starting with 2l+1 for l=0, 1, . . . , N/2−1. The sequence of products of even numbered sets of adjacent symbols includes the sequence of values d₂ₗ×d₂ₗ₋₁×d₂ₗ₋₂ for each 1, and the sequence of products of odd numbered sets of adjacent symbols includes the sequence of values d₂ₗ₊₁×d₂ₗ×d₂ₗ₊₁ for each 1.

In some aspects, generating the second waveform may include applying a second pulse shaping filter to the sequence of the products of the even numbered sets of adjacent symbols and to the sequence of the products of the odd numbered sets of adjacent symbols. In some aspects, generating the first pulse shaping filter p₀(n) and the second pulse shaping filter p₁(n) may involve using an machine learning (ML) algorithm. For example, the transmitter may calculate the first pulse shaping filter and the second pulse shaping filter using a ML algorithm. In some aspects, ML algorithms used for generating the pulse shaping filters p₀(n) and p₁(n) may include supervised learning techniques, which may utilize a binary cross-entropy loss function based on transmitted coded bits, and a vector of received resource elements corresponding to the transmitted coded bits, and the pulse shaping filters, in addition to a PAPR related objective function. The training process may involve iterative refinement of p₀(n) and p₁(n) to minimize the binary cross-entropy and optimize waveform attributes, such as PAPR-related objective functions. An example of the PAPR related objective function may be a weighted sum of time domain sample powers,

$${ℒ}_{PAPR} = {\sum }_{n = 0}^{M} {w}_{n} {\vert {x}_{n} \vert}^{2} ,$$

where {xₙ} are oversampled time-domain samples of the transmitted waveform that is normalized such that E{|xₙ|²}=1, wₙ is a weight computed using a softmax function, given by

$${w}_{n} = \frac{{e}^{{\vert {x}_{n} \vert}^{2} / T}}{{\sum }_{n = 0}^{M} {e}^{{\vert {x}_{n} \vert}^{2} / T}} ,$$

T is a “temperature”, (for example T=0.1), and M is a quantity of generated time domain samples collected within a mini-batch. Lower temperature (for example, T=0.001) results in emphasizing the time domain samples with larger power. Generating the first pulse shaping filter and the second pulse shaping filter may involve using a gradient-based refinement procedure. For example, calculate the first pulse shaping filter and the second pulse shaping filter using a gradient-based refinement procedure. More specifically, backpropagation used in the training of a neural network may be used to learn the first pulse shaping filter and the second pulse shaping filter. The first pulse shaping filter and the second pulse shaping filter may be implemented as learnable parameters. Employing gradient-based refinement may enable more precise tuning of waveform characteristics.

In some embodiments, the first pulse shaping filter, p₀(n), and the second pulse shaping filter, p₁(n), are finite impulse response (FIR) filters of length L. For example, a default implementation may use L=3 for both filters. The coefficients of p₀(n) and p₁(n) may be selected using standard pulse shaping criteria, such as minimizing inter-symbol interference or limiting out-of-band emissions, and may be initialized as a raised cosine window or a Hamming window of length L, normalized to unit energy. The filters may alternatively be determined via a supervised learning procedure in which the objective function includes both a binary cross-entropy term (to preserve bit fidelity) and a PAPR minimization term, as described above. An example set of coefficients for L=3 and N=420 (number of subcarriers) is p₀(n)=[0.45, 0.7, 0.45] and p₁(n)=[0.12, 0.20, 0.12], normalized such that the sum of squares of coefficients equals 1. The filters are applied via N-point circular convolution as described. If no machine learning or data-driven optimization is available, a windowed sine or standard raised-cosine filter of the chosen length may be used as a baseline implementation to achieve the described waveform shaping and PAPR reduction.

Additionally, in some aspects, each symbol of an even numbered set of adjacent symbols and an odd numbered set of adjacent symbols is obtained based on a set of coded bits to be communicated. For example, the transmitter may translate coded bits into symbol arrays for subsequent processing.

In some aspects, calculating the second waveform includes using an equation of the form:

$${s}_{n}^{( 1 )} = - \{ {{\sum }_{l = 0}^{\frac{N}{2} - 1}}^{} ( {d}_{2 l} {d}_{2 l - 1} {d}_{2 l - 2} δ ( n - 2 l ) + {jd}_{2 l + 1} {d}_{2 l} {d}_{2 l - 1} δ ( n - 2 l - 1 ) ) \} * {p}_{1} ( n ) ,$$

$$where {s}_{n}^{( 1 )}$$

is the second waveform, N is a quantity of coded bits to be transmitted, l is an integer, j is a unit imaginary number, 2l is a first symbol delay, 2l+1 is a second symbol delay, {d₂ₗ, d₂ₗ₋₁, d₂ₗ₋₂} is a 2l^{th} set of adjacent symbols transmitted at the first symbol delay, d₂ₗd₂ₗ₋₁d₂ₗ₋₂ is a product of the 2l^{th} set of adjacent symbols transmitted at the first symbol delay, {d₂ₗ₊₁, d₂ₗ, d₂ₗ₋₁} is a (2l+1)^{th} set of adjacent symbols transmitted at the second symbol delay, d₂ₗ₊₁d₂ₗd₂ₗ₋₁ is a product of the (2l+1)^{th} set of adjacent symbols transmitted at the second symbol delay, n is an integer time index ranging from 0 to N−1, * is an N-point circular convolution operator, δ(n) is a discrete time impulse function, and p₁(n) is a second pulse shaping filter and is a function of n. In some such aspects, the even numbered sets of adjacent symbols includes {{d₀, d₋₁, d₋₂}, {d₂, d₁, d₀}, {d₄, d₃, d₂}, . . . , {d₂ₗ, d₂ₗ₋₁, d₂ₗ₋₂}, . . . , {d_{N-2}, d_{N-3}, d_{N-4}}}, and the sequence of products of the even numbered sets of adjacent symbols includes {d₀d₋₁d₋₂, d₂d₁d₀, d₄d₃d₂, . . . , d₂ₗd₂ₗ₋₁d₂ₗ₋₂, . . . , d_{N-2}d_{N-3}d_{N-4}}. Additionally or alternatively, the odd numbered sets of adjacent symbols includes {{d₁, d₀, d₋₁}, {d₃, d₂, d₁}, {d₅, d₄, d₃}, . . . , {d₂ₗ₊₁, d₂ₗ, d₂ₗ₋₁}, . . . , {d_{N-1}, d_{N-2}, d_{N-3}}}, and the sequence of products of the odd numbered sets of adjacent symbols includes {d₁d₀d₋₁, d₃d₂d₁, d₅d₄d₃, . . . , d₂ₗ₊₁d₂ₗd₂ₗ₋₁, . . . , d_{N-1}d_{N-2}d_{N-3}}.

In some aspects, as shown by reference number 315 in FIG. 3A, the transmitter may transmit, and the receiver may receive, a combined waveform. For example, the combined waveform may be obtained by combining the second waveform with the first waveform. For example, by summing the two waveforms, the transmitter creates a composite signal ready for transmission that exhibits a lower PAPR as compared to the individual first waveform. In this way, the second waveform may reduce the PAPR of the first waveform when the second waveform is added to (for example, combined with) the first waveform.

In some aspects, combining the first waveform and the second waveform may include summing the first waveform and the second waveform to obtain the composite waveform. In some aspects, combining the first waveform and the second waveform may include performing a DFT on the summed waveform according to a quantity (for example, N) of REs for transmitting the composite waveform. In some aspects, the combined waveform corresponds to a peak-to-average power ratio that is lower than a baseline peak-to-average power ratio of a waveform generated according to the R/2 BPSK modulation scheme without the second waveform.

For example, waveform construction for the π/2 BPSK waveform may include N coded bits to be transmitted for N REs, given by bₙ∈{0, 1}, for n=0, 1, . . . , N−1. The corresponding BPSK symbols d₀∈{−1,1} are generated according to d₀=1−2bₙ. In some such aspects, bₙ may be periodic with a period N such that b_{n+kN}=bₙ for any integer k. In this way, the waveform in the time domain may be constructed as the sum of two waveforms (for n=0, 1, . . . , N−1), given by

$${s}_{n} = {s}_{n}^{( 0 )} + {s}_{n}^{( 1 )} ,$$

where sₙ is the combined (for example, composite) waveform,

$${s}_{n}^{( 0 )}$$

is the first waveform, and

$${s}_{n}^{( 1 )}$$

is the second waveform. For example, the wireless communication device may assume that a sequence of BPSK symbols is periodic with a specified period.

In some aspects, the composite waveform may be transmitted over a plurality of REs. Additionally, in some aspects, the composite waveform may include one or more samples transmitted over the quantity of REs, wherein one or more samples are assigned a value of zero. For example, one or more of the samples at the output of the N-point DFT may be zeroed-out. In other words, K samples at the output of N-point DFT may be “punctured”, where K is smaller than N. In some aspects, the wireless communication device may indicate the quantity of samples, for example, via the waveform or other signaling.

As shown in FIG. 3B, and by reference number 325, the wireless communication device (for example, a UE 120 or a network node 110) may generate a first waveform,

$${s}_{n}^{( 0 )} ,$$

and a second waveform,

$${s}_{n}^{( 1 )} ,$$

and the transmitter may combine the first waveform and the second waveform to generate a composite waveform.

As shown by reference number 330, the wireless communication device may up-sample samples related to the first waveform and to the second waveform by a factor of 2. In some aspects, the wireless communication device may up-sample the sequence of the products of the even numbered sets of adjacent samples and the sequence of the products of odd numbered sets of adjacent symbols before combining the first waveform with the second waveform. For example, the wireless communication device may process N/2 samples for the first waveform generation (for example, jd₂ₙ for a 2n^{th} BPSK symbol rotated in phase by π/2 transmitted at a first symbol delay given by 2n, and d₂ₙ₊₁ for a (2n+1)^{th} BPSK symbol transmitted at a second symbol delay given by 2n+1). Additionally, the wireless communication device may process N/2 samples for the second waveform generation (for example, −d₂ₙd₂ₙ₋₁d₂ₙ₋₂ for the value of the first function of the 2n^{th} set of adjacent bits transmitted at the first symbol delay given by 2n, and −jd₂ₙ₊₁d₂ₙd₂ₙ₋₁ for the value of the second function of the (2n+1)^{th} set of adjacent bits transmitted at the second symbol delay given by 2n+1.

As shown by reference number 335, after up-sampling, the wireless communication device may apply a sequence delay of one sample. For example, after up-sampling, the wireless communication device may apply a first sequence delay of zero samples to a sequence of even-numbered BPSK symbols rotated in phase by π/2 (for example, the zeroth BPSK symbol rotated in phase by π/2, the second BPSK symbol rotated in phase by π/2, and so on), and the wireless communication device may apply the first sequence delay of zero samples to a first sequence of values, each value in the first sequence of values being the first function of an even-numbered set of adjacent bits (for example the zeroth set of adjacent bits, the second set of adjacent bits, and so on). As a further example, after up-sampling, the wireless communication device may apply a second sequence delay of one sample to the sequence of odd-numbered BPSK symbols (for example, the first BPSK symbol, the third BPSK symbol, and so on), and the wireless communication device may apply the second sequency delay of one sample to a second sequence of values, each value in the second sequence of values being the second function of an odd-numbered set of adjacent bits (for example, the first set of adjacent bits, the third set of adjacent bits, and so on).

As shown by reference number 340, the wireless communication device may sum the respective sequences of products. For example, the device may combine the up-sampled and delayed sequences for subsequent processing.

As shown by reference number 345, the wireless communication device may perform an N-point circular convolution with respect to the first waveform and the second waveform. In some aspects, the wireless communication device may apply a first pulse shaping filter, denoted p₀(n) to the first waveform, and a second pulse shaping filter, denoted p₁(n) to the second waveform. For example, applying the pulse shaping filters may modulate the waveforms' characteristics, enabling reduced spectral interference and improved signal integrity.

As shown by reference number 350, the wireless communication device may sum the first waveform,

$${s}_{n}^{( 0 )} ,$$

and the second waveform,

$${s}_{n}^{( 1 )} .$$

As shown by reference number 355, the wireless communication device may perform an N-point DFT on the summed waveforms in order to create a composite waveform in the frequency domain. In this way, combining the first waveform and the second waveform creates a waveform with reduced PAPR, relative to the first waveform.

As shown in FIG. 3C, and by reference number 360, an example implementation is illustrated for sample delays related to generation of the first waveform. For example, after up-sampling, jd₂ₗ may be sent on an even delay given by 2l, and d₂ₗ₊₁ may be sent on an odd delay given by 2l+1. Furthermore, as shown by reference number 365, an example implementation is illustrated for sample delays related to generation of the second waveform. For example, after upsampling, the value of the products of the 2l^{th} set of adjacent bits may be transmitted at an even delay given by 2l, and the value of products of the (2l+1)th set of adjacent bits transmitted at an odd delay given by 2l+1.

As described herein, the composite waveform formed by combination of the first waveform and the second waveform enables a reduction in PAPR. In some aspects, a wireless communication device may construct a combined waveform based on a π/2-BPSK modulation scheme by combining two waveforms to achieve lower PAPR. The first waveform is generated according to a π/2-BPSK modulation scheme, which includes a first sequence delay for a sequence of even-numbered symbols that is up-sampled and rotated in phase by π/2, and a second sequence delay for a sequence of odd-numbered symbols that is up-sampled. The second waveform further reduces PAPR by employing modulation schemes that include applying first and second functions to sets of adjacent bits (for example, related to lookup tables), and up-sampling these values.

By generating and combining the first and second waveforms as described, the techniques can effectively reduce the PAPR of the transmitted signal. This reduction in PAPR enhances power efficiency and reduces the likelihood of signal distortion during transmission, thereby maintaining high signal integrity, especially in low SNR environments or when operating with limited power budgets. In this way, communicating using the combined waveform may conserve power resources and improve signal integrity in wireless communication systems.

As indicated above, FIGS. 3A-3C are provided as examples. Other examples may differ from what is described with respect to FIGS. 3A-3C.

FIG. 4 is a diagram illustrating an example process 400 performed, for example, at a wireless communication device or an apparatus of a wireless communication device. Example process 400 is an example where the apparatus or the wireless communication device (e.g., UE 120, network node 110) performs operations associated with combined waveforms for signal modulation.

As shown in FIG. 4, in some aspects, process 400 may include generating a first waveform according to a BPSK modulation scheme that includes a first sequence delay for a sequence of even numbered symbols that is up-sampled and rotated in phase, and a second sequence delay for a sequence of odd numbered symbols that is up-sampled (block 410). For example, the wireless communication device (e.g., using communication manager 506, depicted in FIG. 5) may generate a first waveform according to a BPSK modulation scheme that includes a first sequence delay for a sequence of even numbered symbols that is up-sampled and rotated in phase, and a second sequence delay for a sequence of odd numbered symbols that is up-sampled, as described above.

As further shown in FIG. 4, in some aspects, process 400 may include generating a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase (block 420). For example, the wireless communication device (e.g., using communication manager 506, depicted in FIG. 5) may generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase, as described above.

As further shown in FIG. 4, in some aspects, process 400 may include transmitting a combined waveform corresponding to the second waveform and the first waveform (block 430). For example, the wireless communication device (e.g., using transmission component 504 or communication manager 506, depicted in FIG. 5) may transmit a combined waveform corresponding to the second waveform and the first waveform, as described above.

Process 400 may include additional aspects, such as any single aspect or any combination of aspects described below or in connection with one or more other processes described elsewhere herein.

In a first aspect, process 400 includes combining the first waveform and the second waveform to obtain the combined waveform.

In a second aspect, alone or in combination with the first aspect, combining the first waveform and the second waveform comprises summing the first waveform and the second waveform to obtain a summed waveform, and performing a DFT on the summed waveform according to a quantity of resource elements for transmitting the combined waveform.

In a third aspect, alone or in combination with one or more of the first and second aspects, process 400 includes generating the first waveform includes applying a first pulse shaping filter to the sequence of the even numbered symbols and to the sequence of the odd numbered symbols, and generating the second waveform includes applying a second pulse shaping filter to the sequence of the products of the even numbered sets of adjacent symbols and to the sequence of the products of the odd numbered sets of adjacent symbols.

In a fourth aspect, alone or in combination with one or more of the first through third aspects, process 400 includes calculating the first pulse shaping filter and the second pulse shaping filter using a machine learning algorithm.

In a fifth aspect, alone or in combination with one or more of the first through fourth aspects, process 400 includes calculating the first pulse shaping filter and the second pulse shaping filter using a gradient-based refinement procedure.

In a sixth aspect, alone or in combination with one or more of the first through fifth aspects, the first sequence delay is less than the second sequence delay.

In a seventh aspect, alone or in combination with one or more of the first through sixth aspects, a zeroth even numbered set of adjacent symbols includes a zeroth symbol, a negative first symbol, and a negative second symbol, a zeroth odd numbered set of adjacent symbols includes a first symbol, the zeroth symbol, and the negative first symbol, a first even numbered set of adjacent symbols includes a second symbol, the first symbol, and the zeroth symbol, a first odd numbered set of adjacent symbols includes a third symbol, the second symbol, and the first symbol, a second even numbered set of adjacent symbols includes a fourth symbol, the third symbol, and the second symbol, and a second odd numbered set of adjacent symbols includes a fifth symbol, the fourth symbol, and the third symbol.

In an eighth aspect, alone or in combination with one or more of the first through seventh aspects, each symbol of an even numbered set of adjacent symbols and an odd numbered set of adjacent symbols is obtained based on a set of coded bits to be communicated.

In a ninth aspect, alone or in combination with one or more of the first through eighth aspects, process 400 includes up-sampling the sequence of the products of the even numbered sets of adjacent samples and the sequence of the products of odd numbered sets of adjacent symbols before combining the first waveform with the second waveform.

In a tenth aspect, alone or in combination with one or more of the first through ninth aspects, the combined waveform is transmitted over a plurality of resource elements.

In an eleventh aspect, alone or in combination with one or more of the first through tenth aspects, generating the second waveform further includes assuming that a sequence of BPSK symbols is periodic with a specified period.

In a twelfth aspect, alone or in combination with one or more of the first through eleventh aspects, the combined waveform corresponds to a peak-to-average power ratio that is lower than a baseline peak-to-average power ratio of a waveform generated according to the BPSK modulation scheme without the second waveform.

In a thirteenth aspect, alone or in combination with one or more of the first through twelfth aspects, process 400 includes calculating the first waveform using an equation of the form

$${s}_{n}^{( 0 )} = \{ {\sum }_{l = 0}^{\frac{N}{2} - 1} ( j {d}_{2 l} δ ( n - 2 l ) + {d}_{2 l + 1} δ ( n - 2 l - 1 ) ) \} * {p}_{0} ( n ) ,$$

wherein:

$${s}_{n}^{( 0 )}$$

is the first waveform, N is a quantity of coded bits to be transmitted, l is an integer, j is a unit imaginary number, 2l is a first symbol delay, 2l+1 is a second symbol delay, d₂ₗ is a 2l^{th} BPSK symbol transmitted at the first symbol delay, d₂ₗ₊₁ is a (2l+1)th BPSK symbol transmitted at the second symbol delay, n is an integer time index ranging from 0 to N−1, * is an N-point circular convolution operator, δ(n) is a discrete time impulse function, and p₀(n) is a first pulse shaping filter and is a function of n.

In a fourteenth aspect, alone or in combination with one or more of the first through thirteenth aspects, the sequence of even numbered symbols includes {d₀, d₂, d₄, . . . , d₂ₗ, . . . , d_{2N-2}} and the sequence of odd numbered symbols includes {d₁, d₃, d₅, . . . d₂ₗ₊₁, . . . d_{2N-1}}.

In a fifteenth aspect, alone or in combination with one or more of the first through fourteenth aspects, process 400 includes calculating the second waveform using an equation of the form

$${s}_{n}^{( 1 )} = - \{ {\sum }_{l = 0}^{\frac{N}{2} - 1} ( {d}_{2 l} {d}_{2 l - 1} {d}_{2 l - 2} δ ( n - 2 l ) + {jd}_{2 l + 1} {d}_{2 l} {d}_{2 l - 1} δ ( n - 2 l - 1 ) ) \} * {p}_{1} ( n ) , wherein : {s}_{n}^{( 1 )}$$

is the second waveform, N is a quantity of coded bits to be transmitted, l is an integer, j is a unit imaginary number, 2l is a first symbol delay, 2l+1 is a second symbol delay, {d₂ₗ, d₂ₗ₋₁, d₂ₗ₋₂} is a 2l^{th} set of adjacent symbols transmitted at the first symbol delay, d₂ₗd₂ₗ₋₁d₂ₗ₋₂ is a product of the 2l^{th} set of adjacent symbols transmitted at the first symbol delay, {d₂ₗ₊₁, d₂ₗ, d₂ₗ₋₁} is a (2l+1)^{th} set of adjacent symbols transmitted at the second symbol delay, d₂ₗ₊₁d₂ₗd₂ₗ₋₁ is a product of the (2l+1)^{th} set of adjacent symbols transmitted at the second symbol delay, n is an integer time index ranging from 0 to N−1, * is an N-point circular convolution operator, δ(n) is a discrete time impulse function, and p₁(n) is a second pulse shaping filter and is a function of n.

In a sixteenth aspect, alone or in combination with one or more of the first through fifteenth aspects, the even numbered sets of adjacent symbols includes {{d₀, d₋₁, d₋₂}, {d₂, d₁, d₀}, {d₄, d₃, d₂}, . . . , {d₂ₗ, d₂ₗ₋₁, d₂ₗ₋₂}, . . . , {d_{N-2}, d_{N-3}, d_{N-4}}}, and the sequence of products of the even numbered sets of adjacent symbols includes {d₀d₋₁d₋₂, d₂d₁d₀, d₄d₃d₂, . . . , d₂ₗd₂ₗ₋₁d₂ₗ₋₂, . . . , d_{N-2}d_{N-3}d_{N-4}}.

In a seventeenth aspect, alone or in combination with one or more of the first through sixteenth aspects, the odd numbered sets of adjacent symbols includes {{d₁, d₀, d₋₁}, {d₃, d₂, d₁}, {d₅, d₄, d₃}, . . . , {d₂ₗ₊₁, d₂ₗ, d₂ₗ₋₁}, . . . , {d_{N-1}, d_{N-2}, d_{N-3}}}, and the sequence of products of the even numbered sets of adjacent symbols includes {d₁d₀d₋₁, d₃d₂d₁, d₅d₄d₃, . . . , d₂ₗ₊₁d₂ₗd₂ₗ₋₁, . . . , d_{N-1}d_{N-2}d_{N-3}}.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication. The apparatus 500 may be a wireless communication device, or a wireless communication device may include the apparatus 500. In some aspects, the apparatus 500 includes a reception component 502, a transmission component 504, or a communication manager 506, which may be in communication with one another (for example, via one or more buses or one or more other components). In some aspects, the communication manager 506 is the communication manager 150 or the communication manager 155 described in connection with FIG. 1. As shown, the apparatus 500 may communicate with another apparatus 508, such as a UE or a network node (such as a CU, a DU, an RU, or a base station), using the reception component 502 and the transmission component 504. The communication manager 506 may be included in, or implemented via, a processing system (for example, the processing system 140 or the processing system 145, described in connection with FIG. 1) of the wireless communication device.

In some aspects, the apparatus 500 may be configured to perform one or more operations described herein. Additionally, or alternatively, the apparatus 500 may be configured to perform one or more processes described herein, such as process 400 of FIG. 4, or a combination thereof. In some aspects, the apparatus 500 or one or more components shown in FIG. 5 may include one or more components of the wireless communication device described in connection with FIG. 1. Additionally, or alternatively, one or more components shown in FIG. 5 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 502 may receive communications, such as reference signals, control information, data communications, or a combination thereof, from the apparatus 508. The reception component 502 may provide received communications to one or more other components of the apparatus 500. In some aspects, the reception component 502 may perform signal processing on the received communications, and may provide the processed signals to the one or more other components of the apparatus 500. In some aspects, the reception component 502 may include one or more components of the wireless communication device described above in connection with FIG. 1, such as a radio, one or more RF chains, one or more transceivers, or one or more modems, each of which may in turn be coupled with one or more antennas of the wireless communication device.

The transmission component 504 may transmit communications, such as reference signals, control information, data communications, or a combination thereof, to the apparatus 508. In some aspects, one or more other components of the apparatus 500 may generate communications and may provide the generated communications to the transmission component 504 for transmission to the apparatus 508. In some aspects, the transmission component 504 may perform signal processing on the generated communications, and may transmit the processed signals to the apparatus 508. In some aspects, the transmission component 504 may include one or more components of the wireless communication device described above in connection with FIG. 1, such as a radio, one or more RF chains, one or more transceivers, or one or more modems, each of which may in turn be coupled with one or more antennas of the wireless communication device described in connection with FIG. 1. In some aspects, the transmission component 504 may be co-located with the reception component 502.

The communication manager 506 may support operations of the reception component 502 or the transmission component 504. For example, the communication manager 506 may receive information associated with configuring reception of communications by the reception component 502 or transmission of communications by the transmission component 504. Additionally, or alternatively, the communication manager 506 may generate or provide control information to the reception component 502 or the transmission component 504 to control reception or transmission of communications.

The communication manager 506 may generate a first waveform according to a BPSK modulation scheme that includes a first sequence delay for a sequence of even numbered symbols that is up-sampled and rotated in phase, and a second sequence delay for a sequence of odd numbered symbols that is up-sampled. The communication manager 506 may generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase. The transmission component 504 may transmit a combined waveform corresponding to the second waveform and the first waveform.

The communication manager 506 may combine the first waveform and the second waveform to obtain the combined waveform. The communication manager 506 may sum the first waveform and the second waveform to obtain a summed waveform. The communication manager 506 may perform a DFT on the summed waveform according to a quantity of resource elements for transmitting the combined waveform.

The communication manager 506 may apply a first pulse shaping filter to the sequence of the even numbered symbols and to the sequence of the odd numbered symbols.

The communication manager 506 may apply a second pulse shaping filter to the sequence of the products of the even numbered sets of adjacent symbols and to the sequence of the products of the odd numbered sets of adjacent symbols.

The communication manager 506 may calculate the first pulse shaping filter and the second pulse shaping filter using a machine learning algorithm.

The communication manager 506 may calculate the first pulse shaping filter and the second pulse shaping filter using a gradient-based refinement procedure.

The communication manager 506 may up-sample the sequence of the products of the even numbered sets of adjacent samples and the sequence of the products of odd numbered sets of adjacent symbols before combining the first waveform with the second waveform. The communication manager may calculate the first waveform using an equation of the form

$${s}_{n}^{( 0 )} = \{ {\sum }_{l = 0}^{\frac{N}{2} - 1} ( j {d}_{2 l} δ ( n - 2 l ) + {d}_{2 l + 1} δ ( n - 2 l - 1 ) ) \} * {p}_{0} ( n ) , wherein : {s}_{n}^{( 0 )}$$

is the first waveform, N is a quantity of coded bits to be transmitted, l is an integer, j is a unit imaginary number, 2l is a first symbol delay, 2l+1 is a second symbol delay, d₂ₗ is a 2l^{th} BPSK symbol transmitted at the first symbol delay, d₂ₗ₊₁ is a (2l+1)th BPSK symbol transmitted at the second symbol delay, n is an integer time index ranging from 0 to N−1, * is an N-point circular convolution operator, δ(n) is a discrete time impulse function, and p₀(n) is a first pulse shaping filter and is a function of n.

The communication manager 506 may calculate the second waveform using an equation of the form

$${s}_{n}^{( 1 )} = - \{ {\sum }_{l = 0}^{\frac{N}{2} - 1} ( {d}_{2 l} {d}_{2 l - 1} {d}_{2 l - 2} δ ( n - 2 l ) + {jd}_{2 l + 1} {d}_{2 l} {d}_{2 l - 1} δ ( n - 2 l - 1 ) ) \} * {p}_{1} ( n ) , whrerein : {s}_{n}^{( 1 )}$$

is the second waveform, N is a quantity of coded bits to be transmitted, l is an integer, j is a unit imaginary number, 2l is a first symbol delay, 2l+1 is a second symbol delay, {d₂ₗ, d₂ₗ₋₁, d₂ₗ₋₂} is a 2l^{th} set of adjacent symbols transmitted at the first symbol delay, d₂ₗd₂ₗ₋₁d₂ₗ₋₂ is a product of the 2l^{th} set of adjacent symbols transmitted at the first symbol delay, {d₂ₗ₊₁, d₂ₗ, d₂ₗ₋₁} is a (2l+1)th set of adjacent symbols transmitted at the second symbol delay, d₂ₗ₊₁d₂ₗd₂ₗ₋₁ is a product of the (2l+1)^{th} set of adjacent symbols transmitted at the second symbol delay, n is an integer time index ranging from 0 to N−1, * is an N-point circular convolution operator, δ(n) is a discrete time impulse function, and p₁(n) is a second pulse shaping filter and is a function of n.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

The following provides an overview of some Aspects of the present disclosure:

Aspect 1: A method of wireless communication performed by a wireless communication device, comprising: generating a first waveform according to a binary phase shift keying (BPSK) modulation scheme that includes a first sequence delay for a sequence of even numbered symbols that is up-sampled and rotated in phase, and a second sequence delay for a sequence of odd numbered symbols that is up-sampled; generating a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase; and transmitting a combined waveform corresponding to the second waveform and the first waveform.

Aspect 2: The method of Aspect 1, further comprising: combining the first waveform and the second waveform to obtain the combined waveform.

Aspect 3: The method of Aspect 2, wherein combining the first waveform and the second waveform comprises: summing the first waveform and the second waveform to obtain a summed waveform; and performing a discrete Fourier transform (DFT) on the summed waveform according to a quantity of resource elements for transmitting the combined waveform.

Aspect 4: The method of any of Aspects 1-3, wherein: generating the first waveform includes applying a first pulse shaping filter to the sequence of the even numbered symbols and to the sequence of the odd numbered symbols, and generating the second waveform includes applying a second pulse shaping filter to the sequence of the products of the even numbered sets of adjacent symbols and to the sequence of the products of the odd numbered sets of adjacent symbols.

Aspect 5: The method of Aspect 4, further comprising: calculating the first pulse shaping filter and the second pulse shaping filter using a machine learning algorithm.

Aspect 6: The method of Aspect 4, further comprising: calculating the first pulse shaping filter and the second pulse shaping filter using a gradient-based refinement procedure.

Aspect 7: The method of any of Aspects 1-6, wherein the first sequence delay is less than the second sequence delay.

Aspect 8: The method of any of Aspects 1-7, wherein: a zeroth even numbered set of adjacent symbols includes a zeroth symbol, a negative first symbol, and a negative second symbol, a zeroth odd numbered set of adjacent symbols includes a first symbol, the zeroth symbol, and the negative first symbol, a first even numbered set of adjacent symbols includes a second symbol, the first symbol, and the zeroth symbol, a first odd numbered set of adjacent symbols includes a third symbol, the second symbol, and the first symbol, a second even numbered set of adjacent symbols includes a fourth symbol, the third symbol, and the second symbol, and a second odd numbered set of adjacent symbols includes a fifth symbol, the fourth symbol, and the third symbol.

Aspect 9: The method of any of Aspects 1-8, wherein each symbol of an even numbered set of adjacent symbols and an odd numbered set of adjacent symbols is obtained based on a set of coded bits to be communicated.

Aspect 10: The method of any of Aspects 1-9, further comprising: up-sampling the sequence of the products of the even numbered sets of adjacent samples and the sequence of the products of odd numbered sets of adjacent symbols before combining the first waveform with the second waveform.

Aspect 11: The method of any of Aspects 1-10, wherein the combined waveform is transmitted over a plurality of resource elements.

Aspect 12: The method of any of Aspects 1-11, wherein generating the second waveform further includes assuming that a sequence of BPSK symbols is periodic with a specified period.

Aspect 13: The method of any of Aspects 1-12, wherein the combined waveform corresponds to a peak-to-average power ratio that is lower than a baseline peak-to-average power ratio of a waveform generated according to the BPSK modulation scheme without the second waveform.

Aspect 14: The method of any of Aspects 1-13, further comprising: calculating the first waveform using an equation of the form

$${s}_{n}^{( 0 )} = \{ {\sum }_{l = 0}^{\frac{N}{2} - 1} ( {jd}_{2 l} δ ( n - 2 l ) + {d}_{2 l + 1} δ ( n - 2 l - 1 ) ) \} * {p}_{0} ( n ) , wherein : {s}_{n}^{( 0 )}$$

is the first waveform, N is a quantity of coded bits to be transmitted, l is an integer, j is a unit imaginary number, 2l is a first symbol delay, 2l+1 is a second symbol delay, d₂ₗ is a 2l^{th} BPSK symbol transmitted at the first symbol delay, d₂ₗ₊₁ is a (2l+1)^{th} BPSK symbol transmitted at the second symbol delay, n is an integer time index ranging from 0 to N−1, * is an N-point circular convolution operator, δ(n) is a discrete time impulse function, and p₀(n) is a first pulse shaping filter and is a function of n.

Aspect 15: The method of Aspect 14, wherein the sequence of even numbered symbols includes {d₀, d₂, d₄, . . . , d₂ₗ, . . . , d_{2N-2}} and the sequence of odd numbered symbols includes {d₁, d₃, d₅, . . . , d₂ₗ₊₁, . . . , d_{2N-1}}.

Aspect 16: The method of any of Aspects 1-15, further comprising: calculating the second waveform using an equation of the form

$${s}_{n}^{( 1 )} = - \{ {\sum }_{l = 0}^{\frac{N}{2} - 1} ( {d}_{2 l} {d}_{2 l - 1} {d}_{2 l - 2} δ ( n - 2 l ) + {jd}_{2 l + 1} {d}_{2 l} {d}_{2 l - 1} δ ( n - 2 l - 1 ) ) \} * {p}_{1} ( n ) , wherein : {s}_{n}^{( 1 )}$$

is the second waveform, N is a quantity of coded bits to be transmitted, l is an integer, j is a unit imaginary number, 2l is a first symbol delay, 2l+1 is a second symbol delay, {d₂ₗ, d₂ₗ₋₁, d₂ₗ₋₂} is a 2l^{th} set of adjacent symbols transmitted at the first symbol delay, d₂ₗd₂ₗ₋₁d₂ₗ₋₂ is a product of the 2l^{th} set of adjacent symbols transmitted at the first symbol delay, {d₂ₗ₊₁, d₂ₗ, d₂ₗ₋₁} is a (2l+1)^{th} set of adjacent symbols transmitted at the second symbol delay, d₂ₗ₊₁d₂ₗd₂ₗ₋₁ is a product of the (2l+1)^{th} set of adjacent symbols transmitted at the second symbol delay, n is an integer time index ranging from 0 to N−1, * is an N-point circular convolution operator, δ(n) is a discrete time impulse function, and p₁(n) is a second pulse shaping filter and is a function of n.

Aspect 17: The method of Aspect 16, wherein the even numbered sets of adjacent symbols includes {{d₀, d₋₁, d₋₂}, {d₂, d₁, d₀}, {d₄, d₃, d₂}, . . . , {d₂ₗ, d₂ₗ₋₁, d₂ₗ₋₂}, . . . , {d_{N-2}, d_{N-3}, d_{N-4}}}, and the sequence of products of the even numbered sets of adjacent symbols includes {d₀d₋₁d₋₂, d₂d₁d₀, d₄d₃d₂, . . . , d₂ₗd₂ₗ₋₁d₂ₗ₋₂, . . . , d_{N-2}d_{N-3}d_{N-4}}.

Aspect 18: The method of Aspect 16, wherein the odd numbered sets of adjacent symbols includes {{d₁, d₀, d₋₁}, {d₃, d₂, d₁}, {d₅, d₄, d₃}, . . . , {d₂ₗ₊₁, d₂ₗ, d₂ₗ₊₁}, . . . , {d_{N-1}, d_{N-2}, d_{N-3}}}, and the sequence of products of the odd numbered sets of adjacent symbols includes {d₁d₀d₋₁, d₃d₂d₁, d₅d₄d₃, . . . , d₂ₗ₊₁d₂ₗd₂ₗ₋₁, . . . , d_{N-1}d_{N-2}d_{N-3}}.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1−18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

Aspect 26: A device comprising a processing system that includes one or more processors and one or more code-storing memories coupled with the one or more processors, the processing system configured to cause the device to perform the method of one or more of Aspects 1-18.

Aspect 27: A device comprising a processing system that includes processor circuitry and code-storing memory circuitry, the processing system configured to cause the device to perform the method of one or more of Aspects 1-18.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that d₀ not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A wireless communication device, comprising:
a processing system that includes one or more processors and one or more code-storing memories coupled with the one or more processors, the processing system configured to cause the wireless communication device to:
generate a first waveform according to a binary phase shift keying (BPSK) modulation scheme that includes a first sequence delay for a sequence of even numbered symbols that is up-sampled and rotated in phase, and a second sequence delay for a sequence of odd numbered symbols that is up-sampled;
generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase; and
transmit a combined waveform corresponding to the second waveform and the first waveform.

2. The wireless communication device of claim 1, wherein the processing system is configured to cause the wireless communication device to:
combine the first waveform and the second waveform to obtain the combined waveform.

3. The wireless communication device of claim 2, wherein the processing system, to cause the wireless communication device to combine the first waveform and the second waveform, is configured to cause the wireless communication device to:
sum the first waveform and the second waveform to obtain a summed waveform; and
perform a discrete Fourier transform (DFT) on the summed waveform according to a quantity of resource elements for transmitting the combined waveform.

4. The wireless communication device of claim 1, wherein:
generate the first waveform includes applying a first pulse shaping filter to the sequence of the even numbered symbols and to the sequence of the odd numbered symbols, and
generate the second waveform includes applying a second pulse shaping filter to the sequence of the products of the even numbered sets of adjacent symbols and to the sequence of the products of the odd numbered sets of adjacent symbols.

5. The wireless communication device of claim 4, wherein the processing system is configured to cause the wireless communication device to:
calculate the first pulse shaping filter and the second pulse shaping filter using a machine learning algorithm.

6. The wireless communication device of claim 4, wherein the processing system is configured to cause the wireless communication device to:
calculate the first pulse shaping filter and the second pulse shaping filter using a gradient-based refinement procedure.

7. The wireless communication device of claim 1, wherein the first sequence delay is less than the second sequence delay.

8. The wireless communication device of claim 1, wherein:
a zeroth even numbered set of adjacent symbols includes a zeroth symbol, a negative first symbol, and a negative second symbol,
a zeroth odd numbered set of adjacent symbols includes a first symbol, the zeroth symbol, and the negative first symbol,
a first even numbered set of adjacent symbols includes a second symbol, the first symbol, and the zeroth symbol, a first odd numbered set of adjacent symbols includes a third symbol, the second symbol, and the first symbol,
a second even numbered set of adjacent symbols includes a fourth symbol, the third symbol, and the second symbol, and
a second odd numbered set of adjacent symbols includes a fifth symbol, the fourth symbol, and the third symbol.

9. The wireless communication device of claim 1, wherein each symbol of an even numbered set of adjacent symbols and an odd numbered set of adjacent symbols is obtained based on a set of coded bits to be communicated.

10. The wireless communication device of claim 1, wherein the processing system is configured to cause the wireless communication device to:
up-sample the sequence of the products of the even numbered sets of adjacent samples and the sequence of the products of odd numbered sets of adjacent symbols before combining the first waveform with the second waveform.

11. The wireless communication device of claim 1, wherein the combined waveform is transmitted over a plurality of resource elements.

12. The wireless communication device of claim 1, wherein the processing system, to cause the wireless communication device to generate the second waveform, is configured to cause the wireless communication device to assume that a sequence of BPSK symbols is periodic with a specified period.

13. The wireless communication device of claim 1, wherein the combined waveform corresponds to a peak-to-average power ratio that is lower than a baseline peak-to-average power ratio of a waveform generated according to the BPSK modulation scheme without the second waveform.

14. The wireless communication device of claim 1, wherein the processing system is configured to cause the wireless communication device to:
calculate the first waveform using an equation of the form
$${s}_{n}^{( 0 )} = \{ {\sum }_{l = 0}^{\frac{N}{2} - 1} ( {jd}_{2 l} δ ( n - 2 l ) + {d}_{2 l + 1} δ ( n - 2 l - 1 ) ) \} * {p}_{0} ( n ) ,$$
wherein:
$${s}_{n}^{( 0 )}$$
is the first waveform,
N is a quantity of coded bits to be transmitted,
l is an integer,
j is a unit imaginary number,
a first symbol delay is 2l,
a second symbol delay is 2l+1,
d₂ₗ is a 2l^{th} BPSK symbol transmitted at the first symbol delay,
d₂ₗ₊₁ is a (2l+1)th BPSK symbol transmitted at the second symbol delay,
n is an integer time index ranging from 0 to N−1,
* is an N-point circular convolution operator,
δ(n) is a discrete time impulse function, and
p₀(n) is a first pulse shaping filter and is a function of n.

15. The wireless communication device of claim 14, wherein the sequence of even numbered symbols includes {d₀, d₂, d₄, . . . , d₂ₗ, . . . , d_{2N-2}} and the sequence of odd numbered symbols includes {d₁, d₃, d₅, . . . , d₂ₗ₊₁, . . . , d_{2N-1}}.

16. The wireless communication device of claim 1, wherein the processing system is configured to cause the wireless communication device to:
calculate the second waveform using a second equation of the form
$${s}_{n}^{( 1 )} = - \{ {\sum }_{l = 0}^{\frac{N}{2} - 1} ( {d}_{2 l} {d}_{2 l - I} {d}_{2 l - 2} δ ( n - 2 l ) + {jd}_{2 l + 1} {d}_{2 l} {d}_{2 l - 1} δ ( n - 2 l - 1 ) ) \} * {p}_{1} ( n ) ,$$
wherein:
$${s}_{n}^{( 1 )}$$
is the second waveform,
N is a quantity of coded bits to be transmitted,
l is an integer,
j is a unit imaginary number,
a first symbol delay is 2l,
a second symbol delay is 2l+1,
{d₂ₗ, d₂ₗ₋₁, d₂ₗ₋₂} is a 2l^{th} set of adjacent symbols transmitted at the first symbol delay,
d₂ₗd₂ₗ₋₁d₂ₗ₋₂ is a product of the 2l^{th} set of adjacent symbols transmitted at the first symbol delay,
{d₂ₗ₊₁, d₂ₗ, d₂ₗ₋₁} is a (2l+1)^{th} set of adjacent symbols transmitted at the second symbol delay,
d₂ₗ₊₁d₂ₗd₂ₗ₋₁ is a product of the (2l+1)^{th} set of adjacent symbols transmitted at the second symbol delay,
n is an integer time index ranging from 0 to N−1,
* is an N-point circular convolution operator,
δ(n) is a discrete time impulse function, and
p₁(n) is a second pulse shaping filter and is a function of n.

17. The wireless communication device of claim 16, wherein the even numbered sets of adjacent symbols includes {{d₀, d₋₁, d₋₂}, {d₂, d₁, d₀}, {d₄, d₃, d₂}, . . . , {d₂ₗ, d₂ₗ₋₁, d₂ₗ₋₂}, . . . , {d_{N-2}, d_{N-3}, d_{N-4}}}, and the sequence of products of the even numbered sets of adjacent symbols includes {d₀d₋₁d₋₂, d₂d₁d₀, d₄d₃d₂, . . . , d₂ₗd₂ₗ₋₁d₂ₗ₋₂, . . . , d_{N-2}d_{N-3}d_{N-4}}.

18. The wireless communication device of claim 16, wherein the odd numbered sets of adjacent symbols includes {{d₁, d₀, d₋₁}, {d₃, d₂, d₁}, {d₅, d₄, d₃}, . . . , {d₂ₗ₊₁, d₂ₗ, d₂ₗ₋₁}, . . . , {d_{N-1}, d_{N-2}, d_{N-3}}}, and the sequence of products of the odd numbered sets of adjacent symbols includes {d₁d₀d₋₁, d₃d₂d₁, d₅d₄d₃, . . . , d₂ₗ₊₁d₂ₗd₂ₗ₋₁, . . . , d_{N-1}d_{N-2}d_{N-3}}.

19. A method of wireless communication performed by a wireless communication device, comprising:
generating a first waveform according to a binary phase shift keying (BPSK) modulation scheme that includes a first sequence delay for a sequence of even numbered symbols that is up-sampled and rotated in phase, and a second sequence delay for a sequence of odd numbered symbols that is up-sampled;
generating a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase; and
transmitting a combined waveform corresponding to the second waveform and the first waveform.

20. A non-transitory computer-readable medium storing a set of instructions for wireless communication, the set of instructions comprising:
one or more instructions that, when executed by one or more processors of a wireless communication device, cause the wireless communication device to:
generate a first waveform according to a binary phase shift keying (BPSK) modulation scheme that includes a first sequence delay for a sequence of even numbered symbols that is up-sampled and rotated in phase, and a second sequence delay for a sequence of odd numbered symbols that is up-sampled;
generate a second waveform according to a modulation scheme that includes applying the first sequence delay to a sequence of products of even numbered sets of adjacent symbols that is up-sampled and applying the second sequence delay to a sequence of products of odd numbered sets of adjacent symbols that is up-sampled and rotated in phase; and
transmit a combined waveform corresponding to the second waveform and the first waveform.
